(19) United States
(12) Patent Application Publication
(10) Pub. No.: US 2005/0198241 A1
(43) Pub. Date: Sep. 8, 2005

(54) Web server comprising integrated automation functionality and access to a realtime operating system

(76) Inventors: Rolf-Dieter Pavlik, Erlangen (DE); Gernot Rossi, Simmelsdorf (DE); Frank Volkmann, Nurnberg (DE)

Correspondence Address: Siemens Corporation;Intellectual Property Department, 170 Wood Avenue South, Iselin, NJ, 08830, US

(21) Appl. No.: 10/510,312

(22) PCT Filed: Mar. 21, 2003
(86) PCT No.: PCT/DE03/00954

§ 371 Date: Oct. 1, 2004

(30) Foreign Application Priority Data
Apr. 4, 2002 (DE) 10214540.7

(51) Int. Cl. G06F 15/173; G06F 15/16

(52) U.S. Cl. 709/223; 709/205

(57) ABSTRACT

The invention relates to a web server comprising software modules that are integrated in said server. At least one first software module of the web server has first means for a non-proprietary implementation of automation functionality and second means for accessing a real-time operating system.

### CROSS REFERENCE TO RELATED APPLICATIONS

This application is the US National Stage of International Application No. PCT/DE03/00954, filed Mar. 21, 2003 and claims the benefit thereof. The International Application claims the benefits of German application No. 10214540.7 filed Apr. 2, 2002, both of the applications are incorporated by reference herein in their entirety.

### FIELD OF INVENTION

The invention relates to a web server comprising software modules which are integrated into the web server, and an automation system and a computer program product comprising such a web server.

### BACKGROUND OF INVENTION

Servers which are connected to clients by way of the internet and which make available information, normally internet pages, to these clients are referred to as web servers. A web server of this type is an application which runs on one computer or in distributed fashion on a plurality of computers. Data which can be used by a large number of different clients regardless of the particular location of a client is stored centrally on the web server. Both the software application running on a computer and also the computer itself are referred to as the web server. Web servers are used today as universal providers of information on the internet, but they are also used in local networks which are based on internet technologies. In this situation, use is often made of the potential of extension modules for the web servers, for example in order to permit access to databases, forms etc. The communication between client and web server normally takes place in accordance with the HTTP protocol (HTTP=Hyper Text Transfer Protocol).

U.S. Pat. No. 6,061,603 A describes a control system which enables a user to realize a stored program control facility across a communications network such as the internet for example by means of a web browser. The system contains an interface between the network and the stored program control facility. This so-called web interface offers internet pages from an Ethernet interface on the stored program control facility and contains an HTTP protocol interpreter and a TCP/IP stack (TCP/IP=Transmission Control Protocol/Internet Protocol). The web interface thereby provides a remote user with access to the stored program control facility by way of the internet.

### SUMMARY OF INVENTION

The object of the invention is to demonstrate a non-proprietary possible solution for the implementation of an automation functionality.

This object is achieved by a web server comprising software modules whereby at least one first software module has first means for the implementation of an automation functionality and second means for accessing a realtime operating system.

The invention is based on the knowledge that the classical world of automation today has few points of contact with the internet since proprietary protocols are employed predominantly in automation engineering. The development of web technology however continues its advance without consideration for the questions posed by automation engineering. The previous attempts at integrating dedicated web server functionality into the automation components are for their part based on proprietary solutions for the individual components. Moreover, the performance of solutions of that type proved to be very restricted. The web server according to the invention links web technology and automation technology in a surprising manner in that an extension module integrated directly into the web server, a software module as a rule, provides the required automation functionality. A web server having its functionality expanded in such a manner can handle both complex functions concerned with classical automation engineering and also lesser tasks, in the consumer sector for example. As a result of the direct integration of the automation functionality into the web server, existing web implementations can also be utilized when handling the automation function. In order to permit the utilization of web technologies for realtime applications, the web server has a realtime operating system.

Particularly when employed in process automation (drive control in paper manufacturing, for example), the automation components used must have a realtime capability. This requirement is satisfied by coupling the first software module to the realtime operating system. The realtime operating system can be used in addition to a non-realtime operating system (part) or as a sole operating system.

As a result of linking the web server according to the invention to a communications network, to the internet in particular, on the one hand internet technologies are made accessible to automation engineering and on the other hand consistent interfacing of the automation components to the communications network or to the internet is achieved.

The use of internet protocols for the purpose of communications between the software modules and for communications between the software modules and components outside the web server makes it possible to standardize the components of the web server in respect of their communication interfaces. The extension of the web server to incorporate further modules is facilitated since these can be used without requiring costly customization to proprietary protocols. Examples of normal internet protocols are HTTP und FTP (File Transfer Protocol).

In an advantageous embodiment of the invention, the web server is provided for configuration and administration of the software modules.

The web server according to the invention can be easily scaled and can thus be used in accordance with a further advantageous embodiment of the invention for controlling the components of an industrial automation system when the first software module has a link with the industrial automation system.

In order to utilize available internet security mechanisms, it is proposed that the web server has a connection through a firewall to the internet. With regard to the already commonly encountered web server extension features integrated into an automation component, the security mechanisms required on the internet cannot as a rule be implemented on account of their tight requirements.

The connection of the web server to a communications network, to the internet in particular, can be used advantageously in order to support the automation functionality when the web server is connected by way of a communications network to a web browser as an operator control and monitoring system for the automation system controlled by the first software module. This operator control and monitoring system can also be used for project planning, for programming, for carrying out software updates, in other words generally for data communication and data representation purposes.

The invention will be described in detail in the following with reference to the embodiments shown in the attached drawings.

In the drawings:

### BRIEF DESCRIPTION OF THE DRAWINGS

FIG. 1 shows a system comprising web servers connected by way of the internet which perform different tasks;

FIG. 2 shows a web server having automation functionality, and

FIG. 3 shows a schematic view of the structure of a web server having automation functionality.

### DETAILED DESCRIPTION OF INVENTION

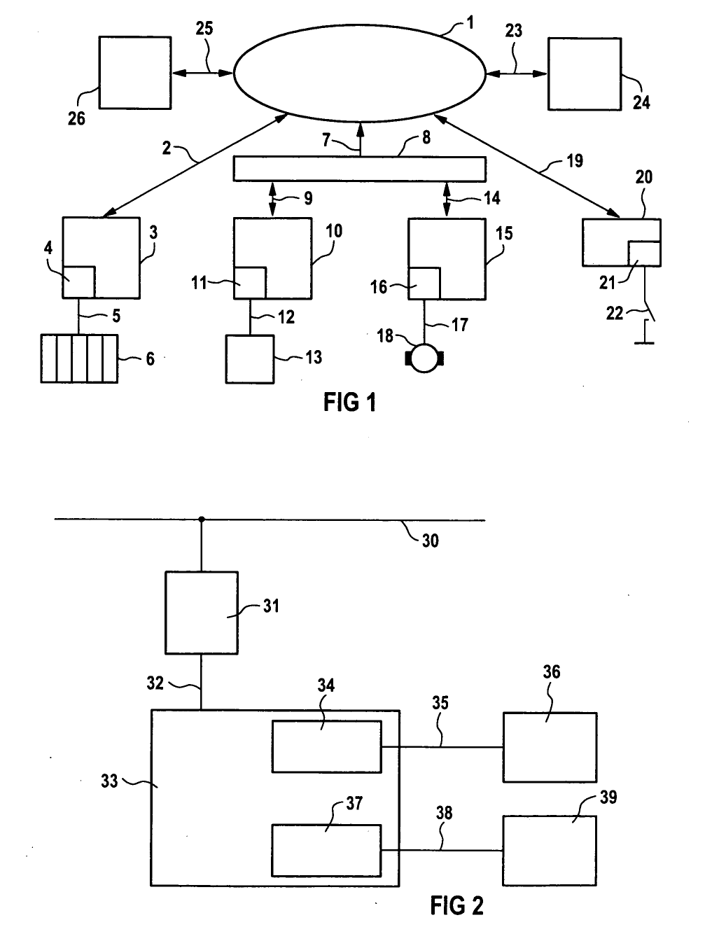

FIG. 1 shows different web servers 3, 10, 15, 20, 24, which are connected to one another either directly or indirectly by way of the internet 1. A first web server 3 communicates directly by way of a connection 2 with the internet 1. The first web server 3 contains an extension module 4 which is connected by way of a connection 5 to an input/output module 6 of an automation system. A second and a third web server 10, 15 are connected by way of connections 9, 14, a firewall 8 and a connection 7 to the internet 1. The second web server 10 has an extension module 11 which has a connection 12 to a converter 13. The third web server 15 contains an extension module 16 which controls a drive 18 by way of a connection 17. The reference character 20 identifies a fourth web server, a so-called embedded web server, which is connected directly by way of a connection 19 to the internet 1 and has an extension module 21 which controls a valve 22. The fifth web server 24 shown in FIG. 1 has no automation functionality whatsoever and communicates with the internet by way of a connection 23. A web browser 26 is connected to the internet 1 by way of a connection 25.

The concept underlying the invention will be described in the following with reference to FIG. 1. A web server is a process on a computer—or it can also be distributed over a plurality of computers—and normally supplies a very large number of clients (web browsers on different machines) with information. This information can either be located statically on the web server or it can however also be generated dynamically by further utility routines. The usual communication partners connected by way of the internet 1 are therefore web servers in the embodiment of the fifth web server 24 and web browser 26. The fifth web server 24 makes available information, generally internet pages, by way of the internet 1 at the request of a web browser 26. The concept of the invention thus consists in configuring such a standard web server through extension by means of software modules in such a way that it is also capable of performing automation functions. The first web server 3 contains an extension module 4 which takes over the functions of a stored program control facility (SPS) or programmable logic control (PLC). To this end, the extension module 4 as part of the web server 3 is connected using a connection 5 to an input/output module of an automation system. The first web server 3 is thus used not only for supplying information by way of the connection 2 onto the internet 1, but can perform complex control functions as a result of the integration of the extension module 4, functions which in the prior art were only capable of being executed by independent stored program control facilities. FIG. 1 shows a further embodiment of the web server according to the invention in the second web server 10 which comprises an extension module 11 having CNC functionality (CNC=Computer Numerical Control). By way of the extension module 11, the second web server 10 controls a computer-controlled machine tool 13 (CNC machine tool) which is used for high-speed and precision manufacture of complicated turned and milled parts. Complicated control functions of this type are normally executed by computers individually specified for the purpose. Control of a drive 18 proves to be a similarly complex control task, which is handled by the third web server 15 in the embodiment. To this end, it contains an extension module 16 which handles the exacting functions involved in control and regulation of the drive 18. In order not to buy the advantages of using web technologies through the second and the third web server 10, 15 at the price of the disadvantage of lacking security, the web servers 10, 15 are linked by way of a firewall 8 to the internet 1. The firewall 8 effectively prevents invalid access attempts over a communication link 7 to one of the web servers and thus to the drive 18 or the machine tool 13. With regard to a further embodiment of the invention shown in FIG. 1, the web server having automation functionality is a so-called embedded web server 20 which in the form of an extension module 21 contains a temperature regulation facility for controlling a valve 22. This embedded web server 20 is implemented for example as a single-chip solution inside a personal computer (PC). In addition to the automation functionality of the extension modules, each of the web servers described 3, 10, 15 and 20 also offers the full functionality and thus all the advantages of a standard web server 24. The web browser 26 linked by way of the internet 1 can thus also access the web servers 3, 10, 15 and 20 expanded to include automation functionality, using web technologies, and thus be used for example as an operator control and monitoring system. The embodiments illustrated in FIG. 1 clearly show the enhanced scalability of the solution proposed here compared with conventional approaches. The web server can be implemented as a single-chip web server with a hardware add-on (for example in the consumer sector) through to the high-performance web server with SoftPLC and Office software.

FIG. 2 shows a schematic view of an embodiment of a web server having automation functionality. A web server 33 is connected by way of a connection 32 and a TCP/IP stack 31 to a TCP/IP link 30. The web server 33 contains a first extension module 34 which is implemented as a database module and has access by means of a connection 35 to an SQL7 server 36 (SQL=Structured Query Language). A second extension module 37 has automation functionality and communicates by way of a connection 38 with an industrial process 39. The extension module 37, a software module, is linked by way of an interface not illustrated here to the connection 38 and thereby to the hardware components of the automation system for controlling the industrial process 39. As upstream software, the TCP/IP stack controls accesses to a network card, not shown here, which has access to the TCP/IP link 30, and makes the TCP/IP protocol available to the accessing processes.

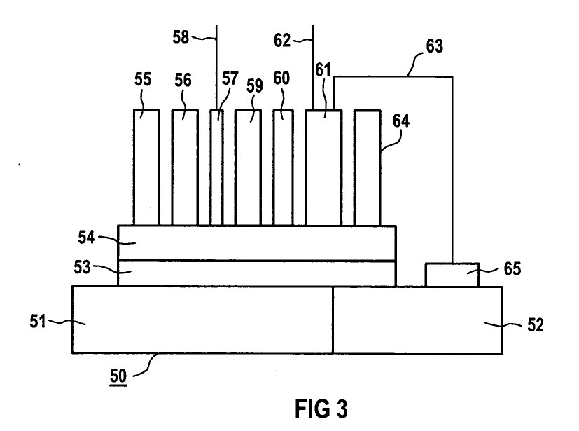

FIG. 3 shows the schematic view of the structure of a further embodiment of a web server having automation functionality. Software components of the web server are illustrated. An operating system 50 on the computer on which the web server is running comprises a standard operating system 51 and also a realtime operating system 52. A web server kernel 54 is superimposed onto the underlying operating system 50 by means of a porting facility 53. The web server kernel 54 can also run in the realtime operating system 52. The web server kernel 54 provides standardized interfaces for coupling with the software components and is the basis for different software extension modules. A first extension module 55 is used for the provision of web pages, a second extension module 56 is used as an XML parser. A third extension module 57 serves to connect up a Profibus connection 58. A fourth extension module 59 offers Java functionality, a fifth extension module 60 processes signals from a webcam. A sixth extension module 64 is used for processing XML data. A seventh extension module 61 having automation functionality has a link 62 to a process and a link 63 to an interface 65 with the realtime operating system 52. A system is regarded as having a realtime capability if it is able to react to random external events within a specifiable and guaranteeable time. In industrial automation systems, reaction times in the microsecond range are usual and required. Realtime processes can utilize all the services which are also available to other processes.

The operating system 50 has direct access to the resources of the computer, such as memory and computing time for example. When a command is issued or a program invoked, then the required program code is loaded into a main memory and started as a process. Processes do not have access to the resources, they request these from the operating system in each case. As a result of the direct integration of the automation functionality as the seventh extension module 61 into the web server, the performance, the services (autotopology, SSDP, SNMP, e-mail etc. for example} and the openness of the internet are made accessible to the world of automation and the further advantages described above are achieved. The seventh extension module 61 on the one hand implements the automation solution and on the other hand exchanges information by way of the web server and is configured and administered by the latter. In contrast to this, in the case of a so-called SoftPLC (=software simulation of a stored program control facility) the automation function is not integrated into the server but is installed in parallel with the latter, possibly linked in by way of a communication interface. Integration into the server means in particular that an extension module is loaded, configured, started and terminated directly by the web server. Such an extension module is often also referred to as an “extension”. The web server kernel 54 of the web server according to the invention is used as a common platform for the extension modules. This facilitates in particular the configuration of the software extension modules and their re-use in other applications. Linking in of the extension modules is not handled using proprietary or programmed interfaces, but by using standardized interfaces, for example API (Application Programming Interface) or CGI (Common Gateway Interface). API is a formally defined interface which allows application programs to use system services (network, operating system etc.) or service facilities offered by other application programs. CGI describes a standard interface between a web server and programs. As the means for implementing an automation functionality, the seventh extension module 61 has regulation and/or control facilities for the regulation and/or control of components and also processes of an automation system. These regulation and control facilities for controlling an automation system normally take the form of software processes capable of executing in the extension module.

The proposed web server is part of a system of distributed applications constructed in a client-server architecture. In such a system it is the task of a server as the provider of a service to perform calculations or execute other internal processes in response to requests from a client and to formulate the results as protocol-compliant responses and forward them to the requesting client. In this situation, client is understood to refer to a device or a process which takes advantage of the service from one or more servers. Normally therefore the server makes a service available passively and waits for the client to make a request to the server. The client on the other hand does not provide any services but takes advantage of services provided by a server. In this situation, a server as the provider of a service can be situated on the same device as the client or on a different device accessible by way of a network (the internet, for example). The client-server communication obeys certain rules and formal descriptions, the so-called protocols. It is an indispensable prerequisite for successful communication between client and server that both sides use the same protocol. Such a protocol normally specifies the communication channels and the formats which are used for login, information exchange, request, response and logout. Not all these steps always need to be specified explicitly if they are not of importance to the application. Protocols are specified on widely differing levels of abstraction and are normally based one upon the other. One then speaks of a layer model (ISO/OSI layer model, for example). Whereas the lowermost layers regulate the communication of hardware and equipment—electrical signals, cables or radio frequencies and their properties are specified, middle layers are concerned with the structure of network topologies (address structures and their resolution, routing and error correction). The network layer (IP=Internet Protocol, for example) and the transport layer (TCP=Transmission Control Protocol, for example) are often separated here. The uppermost layers are referred to as the application layer. This serves to specify how concrete client-server applications communicate with one another. Examples of such protocols for the application layer are HTTP (Hyper Text Transfer Protocol), FTP (File Transfer Protocol) and SMTP (Simple Mail Transfer Protocol).

To summarize, the invention thus relates to a web server comprising software modules that are integrated into the web server, whereby at least one first software module 37 has first means for the non-proprietary implementation of an automation functionality and secondar means 63, 65 for accessing a realtime operating system 52.

1-9. (canceled)

10. A web server comprising software modules, wherein at least one first software module comprises a first mechanism for implementing an automation functionality and a second mechanism for accessing a real-time operating system.

11. The web server according to claim 10, wherein the web server comprises a connection to a communications network.

12. The web server according to claim 11, wherein the communications network is the Internet.

13. The web server according to claim 10, wherein internet protocols are provided for communication between the software modules and for communication between the software modules and components outside the web server.

14. The web server according to claim 11, wherein internet protocols are provided for communication between the software modules and for communication between the software modules and components outside the web server.

15. The web server according to claim 10, wherein the web server is adapted for configuring and administrating the software modules.

16. The web server according to claim 11, wherein the web server is adapted for configuring and administrating the software modules.

17. The web server according to claim 13, wherein the web server is adapted for configuring and administrating the software modules.

18. The web server according to claim 10, wherein the first software module comprises a connection with an industrial automation system.

19. The web server according to claim 11, wherein the first software module comprises a connection with an industrial automation system.

20. The web server according to claim 13, wherein the first software module comprises a connection with an industrial automation system.

21. The web server according to claim 15, wherein the first software module comprises a connection with an industrial automation system.

22. The web server according to claim 10, wherein the web server comprises a connection to the internet using a firewall.

23. The web server according to claim 11, wherein the web server comprises a connection to the internet using a firewall.

24. The web server according to claim 13, wherein the web server comprises a connection to the internet using a firewall.

25. The web server according to claim 10, wherein the web server is connected by a communications network to a web browser as an operating and monitoring system.

26. The web server according to claim 11, wherein the web server is connected by a communications network to a web browser as an operating and monitoring system.

27. The web server according to claim 13, wherein the web server is connected by a communications network to a web browser as an operating and monitoring system.

28. An automation system comprising a web server, wherein the web server comprising software modules, wherein a first software module comprises a first mechanism for implementing an automation functionality and a second mechanism for accessing a real-time operating system.

29. A computer program product comprising a web server comprising software modules, wherein a first software module comprises a first mechanism for implementing an automation functionality and a second mechanism for accessing a real-time operating system.
